(19) United States
(12) Patent Application Publication
(10) Pub. No.: US 2020/0317856 A1
(43) Pub. Date: Oct. 8, 2020

(54) METHOD FOR PRODUCING TEMPERATURE-STABLE POLYALKENYLENES

(71) Applicant: EVONIK OPERATIONS GMBH, Essen (DE)

(72) Inventors: Kévin Micoine, Herten (DE); Velichka KOLEVA, Reken (DE); Ralf MEIER, Dortmund (DE); Pedro VAZQUEZ TORAN, Valencia (ES)

(21) Appl. No.: 16/954,739

(22) PCT Filed: Dec. 18, 2018
(86) PCT No.: PCT/EP2018/085630

§ 371 Date: Jun. 17, 2020

(30) Foreign Application Priority Data
Dec. 18, 2017 (EP) 17208211.7

(51) Int. Cl. C08G 61/08; B01D 61/14; B01D 71/70; B01D 71/64

(52) U.S. Cl. CPC C08G 61/08; B01D 61/145; B01D 71/70; B01D 71/64; C08G 2261/11; C08G 2261/1642; B01D 2315/16; C08G 2261/3322; C08G 2261/418; C08G 2261/592; C08G 2261/712; B01D 2315/10; C08G 2261/20

(57) ABSTRACT

The present invention relates to a process for producing cycloalkenamer-containing compositions. The polymerization of cycloalkenamer is stopped by addition of alkyl vinyl ethers. This is followed by a membrane filtration. This type of production affords polyalkenamers that are thermally stable at 180° C.

The present invention relates to a process for producing polyalkenamer-containing compositions. The invention further relates to the use of polyalkenamer-containing compositions and polyoctenamer.

Polyalkenamers such as polyoctenamer (for example Vestenamer® from Evonik) are employed for example in tires, rubber articles, adhesives or packaging. The melting point is important in many applications since a polyalkenamer having a relatively high melting point has a relatively high crystallinity which results in better mechanical properties in most applications.

Polyoctenamers may be produced by ring-opening metathesis of cyclooctene. A catalyst must be added for this purpose. Suitable catalysts are for example tungsten complexes (U.S. Pat. Nos. 3,597,406, 4,095,033, DE2619197), molybdenum complexes (EP0218138; Polymer 1995, 36, 2787-2796) and ruthenium complexes (J. Am. Chem. Soc. 1993, 115, 9858-9859; Macromolecules 1993, 26, 4739-4741). Ruthenium carbenes in particular are very widely applicable and tolerate all common chemical groups (EP0626402, U.S. Pat. No. 8,324,334, US2016/159942). Very particularly suitable are ruthenium-carbene complexes which, as one of their characteristic features, bear an N-heterocyclic carbene ligand.

Ring-opening polymerization reactions may be stopped for example by addition of alkyl vinyl ethers such as ethyl vinyl ether or butyl vinyl ether or of alkyl vinyl sulfides such as ethyl vinyl sulfide (Macromolecules 2000, 33, 6239-6248). This forms a Fischer carbene which does not catalyze the ring opening metathesis. The ruthenium carbene is also detached from the polymer chain by this chemical reaction.

The existing production processes with Mo or W catalysts can produce polyoctenamers having a melting point of no more than 54° C. to 56° C. In addition, such polymers typically contain high metal constituents and high chloride proportions. These are present at levels of more than 50 ppm of tungsten or molybdenum and more than 50 ppm of aluminium (for Al-based cocatalysts) and more than 50 ppm of chloride. The chloride and metal traces remain in the polymer material and cannot be separated easily. These metal traces must be kept as low as possible for many applications, for example in the foodstuffs industry or in medicine.

After synthesis on a production scale polyoctenamer is dried under vacuum at a temperature of 180° C. over several hours to fully remove the solvent of the reaction. Furthermore, depending on the application the polymer may be processed at high temperatures. During these high temperature treatments, side reactions which lower the melting point and the melting enthalpy of the polymer may take place. The melting points of polyalkenamer are often below 40° C. A reduction in the melting point and in the melting enthalpy constitutes a change in the physicochemical properties of the polymer which is not acceptable in a great many applications.

WO 2017/060363 describes the purification of polyalkenamers by membrane filtration. The polymer is produced with a tungsten/aluminium catalyst system and has a melting point of 54° C. In addition, metal proportions of aluminium and tungsten of more than 50 ppm are present. Also described is the reaction with ruthenium carbenes as catalyst. However, the catalyst or a decomposition product of the catalyst (inorganic ruthenium species) can block the membrane material.

The present invention has for its object to provide polyalkenamers which do not exhibit the disadvantages of the prior art. The polyalkenamers should have a higher melting point compared to known polyalkenamers. In addition, the polyalkenamers should contain the smallest possible metal proportions. The polyalkenamer should moreover retain its properties such as its melting point at a processing temperatures of 180° C. and thus be thermally stable. A polyoctenamer should have a melting point of at least 57° C.

Surprisingly, a process for producing polyalkenamers by means of which object was achieved has now been found. The inventive process for producing a polyalkenamer-containing composition comprises the following steps:
a) reacting at least one cycloalkane by ring-opening metathesis polymerization in at least one organic solvent to obtain a polyalkenamer-containing product mixture, wherein the polymerization is performed in the presence of at least one metal-containing catalyst and wherein the metal is selected from rhenium, ruthenium, osmium or mixtures thereof,
b) adding at least one alkyl vinyl derivative selected from alkyl vinyl ether, alkyl vinyl sulfide or mixtures thereof after the polymerization and
c) working up the product mixture to remove the catalyst to obtain the polyalkenamer-containing composition, wherein the workup is carried out by membrane filtration in at least one organic solvent.

It has been found that, surprisingly, the thermal stability of the polyalkenamers is significantly improved when Fischer carbenes (catalyst-alkyl vinyl ether adduct/catalyst-alkyl vinyl sulfide adduct) are formed with the catalysts by the addition of an alkyl vinyl ether/alkyl vinyl sulfide after the polymerization step and a subsequent membrane filtration is carried out. In addition, these Fischer carbenes can be separated more efficiently than other metal-containing catalysts in the membrane filtration. This makes it possible to obtain polyalkenamers having low metal proportions. The melting points are higher than the melting points of polyalkenamers produced by processes of the prior art. Polyoctenamer obtained by the process according to the invention has a melting point of at least 57° C. after heat treatment (180° C. over 20 h, pressure 1 mbar).

The cycloalkene is selected from the group consisting of cyclobutene, cyclopentene, cycloheptene, cyclooctene, cyclononene, cyclodecene, cyclododecene, cycloocta-1,5-diene, 1,5-dimethylcycloocta-1,5-diene, cyclodecadiene, norbornadiene, cyclododeca-1,5,9-triene, trimethylcyclododeca-1,5,9-triene, norbornene (bicyclo[2.2.1]hept-2-ene), 5-(3′-cyclohexenyl)-2-norbornene, 5-ethyl-2-norbornene, 5-vinyl-2-norbornene, 5-ethylidene-2-norbornene, dicyclopentadiene and mixtures thereof. Particular preference is given to cyclopentene, cycloheptene, cyclooctene and cyclododecene. Cyclooctene is an outstanding cycloalkene because of its availability and ease of handling. It is preferable when the cycloalkene comprises cycloctene and particularly preferable when it consists of this monomer. It is possible to use two or more cycloalkenes to form copolymers of the polyalkenamer. The cycloalkenes may be substituted with alkyl groups, aryl groups, alkoxy groups, carbonyl groups, alkoxycarbonyl groups and/or halogen atoms.

The polymerization reaction is performed in at least one organic solvent. Suitable solvents are in particular nonpolar aromatic or aliphatic solvents, aprotic nonpolar, aliphatic solvents being preferred. Suitable are for example saturated aliphatic hydrocarbons such as hexane, heptane, octane, nonane, decane, dodecane, cyclohexane, cycloheptane or cyclooctane; aromatic hydrocarbons such as benzene, toluene, xylene or mesitylene; halogenated hydrocarbons such as chloromethane, dichloromethane, chloroform or carbon tetrachloride; ethers such as diethyl ether, tetrahydrofuran or 1,4-dioxane; ketones such as acetone or methyl ethyl ketone; esters such as ethyl acetate; and mixtures of the aforementioned solvents. The solvent for the reaction is particularly preferably selected from the group consisting of aliphatic alkanes having five to twelve carbon atoms, yet more preferably five to eight carbon atoms, and toluene. Also preferably selected are tetrahydrofuran, methyl ethyl ketone, chloromethane, dichloromethane, chloroform or mixtures thereof. Hexane or toluene are very particularly preferred, hexane being singled out in particular. The content of solvent may be set, for example, to a value of 20% to 60% by weight, preferably of 40% to 60% by weight, based on the total weight of cycloalkene and solvent.

When choosing the solvents for the ring-opening metathesis reaction it should be noted that the solvent should not deactivate the catalyst or the catalytically active species. Those skilled in the art can identify this by simple experiments or by studying the literature.

The polymerization is preferably performed at temperatures of 20° C. to 100° C., preferably 30° C. to 80° C. The pressure in the synthesis apparatus is typically 1 to 7 bar. During the polymerization the monomer concentration of cycloalkane is 0.1% to 60% by weight, preferably 20% to 50% by weight, in each case based on the total weight of cycloalkane and catalyst and any chain transfer agent and solvents present.

Metal-containing catalysts are employed to catalyze the polymerization. Suitable metals are rhenium, ruthenium, osmium or mixtures thereof, ruthenium-containing catalysts being preferred. Metal-carbene complexes bearing an N-heterocyclic carbene ligand are particularly suitable. Examples of suitable catalysts include

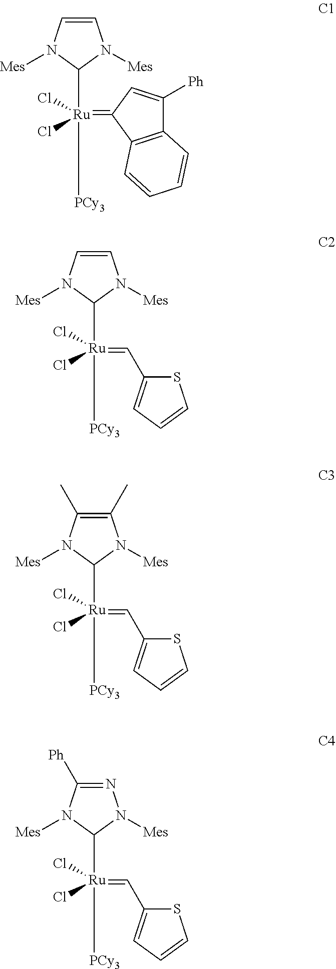

Tungsten-containing catalysts customary in the prior art are not suitable for the present process. The addition of alkyl vinyl ether does not bring about formation of Fischer carbenes and the metals of the catalyst cannot be effectively separated by membrane filtration. In addition, the melting point for example of polyoctenamer produced using tungsten catalyst is below 57° C.

To terminate the polymerization alkyl vinyl ether/alkyl vinyl sulfide is added. Suitable alkyl vinyl ethers are preferably selected from methyl vinyl ether, ethyl vinyl ether, propyl vinyl ether, butyl vinyl ether and mixtures thereof. Preference is given to ethyl vinyl ether, butyl vinyl ether and mixtures thereof. Suitable alkyl vinyl sulfides are preferably selected from methyl vinyl sulfide, ethyl vinyl sulfide, propyl vinyl sulfide, butyl vinyl sulfide and mixtures thereof. Preference is given to ethyl vinyl sulfide, butyl vinyl sulfide and mixtures thereof.

The amount of substance of alkyl vinyl ether/alkyl vinyl sulfide is at least equal to the amount of substance of ruthenium catalyst, preferably at least ten times the amount of substance.

After addition of alkyl vinyl ether/alkyl vinyl sulfide the catalyst is separated from the polyalkene-containing product mixture by membrane filtration. After the member filtration has been performed the worked-up product mixture preferably contains less than 50 ppm of rhenium, less than 50 ppm of ruthenium and less than 50 ppm of osmium. Less than 20 ppm of rhenium, less than 20 ppm of a ruthenium and less than 20 ppm of osmium are particularly preferred. It is very particularly preferred when the content of the sum total of the three metals is less than 10 ppm more preferably less than 5 ppm and in particular less than 2 ppm. This relates in each case to the worked-up polyalkenamer-containing composition after heat treatment at 180° C. and 1 mbar for 20 h.

The product mixture comprises polyalkenamers and catalyst-alkyl vinyl ether adduct/catalyst-alkyl vinyl sulfide adduct. Unreacted monomer and possibly oligomers may also be present. Oligomers copolymers having molecular mass below 3000 g/mol. The present mixture is supplied to a filtration membrane for workup. This type of membrane filtration may be an ultrafiltration or a nanofiltration for example, preferably an ultrafiltration. In this step the smaller molecules (monomers, oligomers and catalyst-alkyl vinyl ether adduct/catalyst-alkyl vinyl sulfide adduct) are separated from the polymer by permeating through the membrane. Fresh solvent is added to wash the small components through the membrane. In this way the monomers, oligomers and catalyst-alkyl vinyl ether adduct/catalyst-alkyl vinyl sulfide adduct pass into the permeate and the polyalkenamer remains in the retentate.

At least one solvent that is also suitable for the polymerization is selected for the membrane filtration. The solvent for the membrane filtration may be the same as or different from the solvent in which the polymerization has been performed. It is preferable when the same solvent is used for the polymerization and the membrane filtration. Thus steps a), b) and c) are each performed in an organic solvent, and so the polyalkenamer-containing product mixture is always present in solution.

The membrane filtration typically employs 0 to 10 washing volumes (1 washing volume=1 feed volume), preferably 1 to 5 washing volumes. The thus obtained polymer solution may be subjected to further processing (for example and drying, compounding etc.).

The membrane separation may be effected either by ultrafiltration or else by a nanofiltration. Suitable conditions for the ultrafiltration are: proportion of polymer of 0.1% to 70% by weight based on the product mixture, temperature of 20° C. to 100° C., preferably 30° C. to 80° C. and pressure of 0 to 6 bar. Suitable conditions for the nanofiltration are: proportion of polymer of 0.1% to 70% by weight based on the product mixture, temperature of 20° C. to 100° C., preferably 30° C. to 80° C. and pressure of 10 to 60 bar.

The permeate from the membrane filtration may be supplied to a nanofiltration membrane to recover the catalyst-alkyl vinyl ether adduct/catalyst alkyl vinyl sulfide adduct and the separated oligomers. The retentate from the nanofiltration comprising the adduct may be recycled to the polymerization reaction. The catalyst may first require reactivation. The recycling significantly reduces the consumption of fresh catalyst in the polymerization step. The permeate from this nanofiltration which is predominantly free from oligomers and adduct may be recycled into the ultrafiltration as washing solvent. This allows the consumption of fresh solvent to be significantly reduced. Alternatively, the solvent may be distilled and reused.

Typical molecular separation limits of the ultrafiltration membrane at which 90% of the molecules of a particular molar mass are retained are between 1000 to 100 000 g/mol (T. Melin, R. Rautenbach, Membranverfahren: Grundlagen der Modul- and Anlagenauslegung, 3rd ed., Springer 2007, p. 313).

The separation limit of nanofiltration membranes is between 100 and 2000 g/mol (T. Melin, R. Rautenbach, Membranverfahren: Grundlagen der Modul- and Anlagenauslegung, 3rd ed., Springer 2007, p. 286, diagram). Accordingly, a suitable membrane may be a nano- or ultrafiltration membrane. A suitable membrane having the desired separation capacity is stable in the solvent or solvent mixture used.

The membrane of the membrane filtration preferably comprises a separation layer made of polymer, glass, metal, ceramic or mixtures thereof.

Suitable inorganic membranes are selected from porous metallic materials, ceramic membranes and polymer ceramic membranes, each of which may be selected from aluminium oxide, titanium dioxide, zirconium dioxide, silicon dioxide, titanium nitrite, silicon carbide or mixtures and modifications thereof. Ceramic membranes of this kind are supplied, for example, by Inopor GmbH, PALL Corporation or TAMI Industries. An overview of suppliers may be found in R. Mallada, M, Inorganic Membranes: Synthesis, Characterization and Applications, Elsevier, 2008, p. 182, table 6.1. Because of the relatively high ratio of active membrane area to system volume, membranes in the form of spiral-wound modules of polymer membranes are particularly preferred.

Preference is given to solvent-stable polymer membranes, as described, for example, in US 2012/0123079, WO 2010/142979, US 2012/0279922 or EP 0943645B1.

Suitable membrane separation layers are described, for example, in WO 2010/142979, US 2012/0279922 or EP 0943645B1. Suitable polymers are suitable for organic solvents in particular. The membrane separation layers are preferably selected from polydimethysiloxanes (PDMS) or modifications thereof (especially acrylate modifications), polyacrylonitriles (PAN), polyimides (PI), polyetheretherketones (PEEK), polyvinylidene fluorides (PVDF), polyamides (PA), polyamidimides (PAD), polyethersulfones (PES), polybenzimidazoles (PBI), sulphonated polyetheretherketones (SPEEK), polyethylenes (PE) and polypropylenes (PP). Less preferred are membranes optimized for aqueous systems. These usually include polymers such as cellulose acetate (CA), polyethersulphones (PES) and polysulphones (PS).

Suitable membranes made of crosslinked silicone acrylates are described for example in US 2015/0328619.

In a particular embodiment of the invention the separation-active layer of the membrane is selected from crosslinked silicone acrylates, polydimethylsiloxane (PDMS) and polyimide.

Establishment of parameters such as selection of the material of the membrane separation layer, temperature, pressure and membrane surface area can be undertaken by the those skilled in the art by suitable preliminary experiments. Forecasting models for the performance of employed membranes are not yet available.

After the membrane separation, the solvent in which the polyalkenamer-containing composition is dissolved may be removed. This can be undertaken by heating or pressure reduction, for example by means of vacuum degassing. Alternatively or in addition, a drying operation may be performed, for example under reduced pressure and/or at elevated temperature, to remove the solvent. The solid obtained can be pelletized to afford particles, for example by strand pelletization or underwater pelletization, or pulverized, for example by spray-drying or grinding.

The process according to the invention may be performed continuously or batchwise.

It is preferable when the polyoctenamer has a weight-average molecular weight (Mw) of 3000 g/mol to 500 000 g/mol, preferably of 2000 g/mol to 400 000 g/mol and particularly preferably of 5000 to 350 000 g/mol. The method of measurement is specified in the examples.

The desired molar weight may for example be established in the presence of at least one chain transfer agent which allows chain growth to be terminated. Suitable chain transfer agents are known from the literature and include for example acyclic alkenes having one or more nonconjugated double bonds which may be terminal or internal and which preferably do not bear any substituents. Such compounds are, for example, pent-1-ene, hex-1-ene, hept-1-ene, oct-1-ene or pent-2-ene. Alkyl vinyl ethers do not fall within this definition as they are not usable as chain-transfer agents. The reason for this is that alkyl vinyl ethers deactivate the catalyst. Alternatively employable as chain-transfer agents are cyclic compounds comprising a double bond in their side chain, for example vinylcyclohexene.

The cis/trans ratio of the cycloalkenamers can be adjusted by methods familiar to those skilled in the art. The ratio depend for example on catalysts, solvents, stirring intensity or temperature or reaction time. It is preferable when the trans content is at least 55%, preferably at least 70% and particularly preferably 75% to 85%. The cis/trans ratio is determined by ¹H NMR in deuterochloroform.

The invention likewise provides for the use of at least one polyalkenamer-containing composition produced according to the invention in tires, rubber articles, adhesives or packaging materials, wherein the packaging materials are preferably used for foodstuffs.

The invention further provides polyoctenamer having a melting point of at least 57° C., preferably 57° C. to 60° C., preferably 58° C. to 60° C., particularly preferably 59° C. to 60° C., after heat treatment at a temperature of 180° C. and a pressure of 1 mbar for 20 h. The polyalkenamer according to the invention is preferably produced by the process according to the invention.

### EXAMPLES

Methods of Determination

Weight-Average Molecular Weight

Determination of molecular weight was carried out by gel permeation chromatography (GPC) as per DIN 55672-1:2016-03. Measurements were performed with a GPC system from Knauer Wissenschaftliche Geräte GmbH. The polymer was measured as a solution in tetrahydrofuran (c=5 g/L, injection volume 100 μL) on an SDV column (30 cm, 5 μm, linear) with pre-column (SDV 5 cm, 5 μm, 100 Å) at 23° C. and a flow rate of 1 mL/min. Calculation of the average molar masses was carried out by means of the strip method against polystyrene standards. WinGPC UniChrom (Build 5350) software from PSS Polymer Standards Service GmbH was employed for evaluation.

Melting Point and Melting Enthalpy.

Determination of melting point and melting enthalpy was carried out by differential scanning calorimetry (DSC). Polymer samples between 5 and 10 mg were measured. Measurements were performed on a PerkinElmer DSC-7 instrument with 20 mL/min of nitrogen 5.0 as purging gas. The measurement program contained a first heating from −90° C. to 80° C. (heating rate 20 K/min), a cooling from 80° C. to −90° C. (cooling rate 20K/min) and a second heating from −90° C. to 80° C. (heating rate 20 K/min). The melting point and the melting enthalpy of the polyalkenamers was determined using the second heating.

Trace Elemental Analysis

Determination of trace elements from the catalyst in the polyalkenamer were performed quantitatively by ICP-MS. 0.1-0.2 g of sample were digested in 10 ml of 65% by weight HNO₃ and 2 mL of water at not more than 130 bar of pressure and not more than 300° C. The digestate was evaporated in a closed system at not more than about 95° C., dissolved with 0.5 mL of HNO₃ and made up to 20 mL with water. The content of various elements in the solution was determined quantitatively with a Thermo Fisher “ICAP Q” quadrupole ICPMS.

### Example 1A: Synthesis of Polyoctenamer in Heptane with Tungsten/Aluminium Catalyst System

585 mL of heptane, 100 g of cyclooctene (COE) and 0.34 g of vinyl cyclohexene (VCH) were charged into a dry 2 L glass reactor under argon. The reaction mixture was heated to 30° C. and 0.4 mL of a solution of ethylaluminium dichloride (20% by weight) in heptane was added. Subsequently, 1 mL of a solution of tungsten hexachloride/propylene oxide (⅓ mol/mol) in toluene (2.8% by weight of tungsten) were added slowly. A temperature increase of 5° C. was observed and the reaction mixture became markedly more viscous. The contents of the reactor were then discharged and a solution of 20% by weight of polyoctenamer in heptane was obtained.

### Example 1B (Comparative Example): Membrane Purification of Polyoctenamer in Heptane with Tungsten/Aluminium Catalyst System

1.25 L of the solution of 20% by weight of polyoctenamer in heptane (produced as per example 1A) was further diluted to 5% by weight with 3.75 L of heptane. The obtained 5 L of polymer solution was purified by diafiltration through a PuraMem® UF (cut-off about 35 000 Da) ultrafiltration polymer membrane from Evonik Resource Efficiency GmbH. This was carried out using a crossflow filtration system with an 1812 membrane module (membrane area about 0.14 m²). In a diafiltration the membrane is used as a semipermeable barrier, the large molecules (polymer) being retained and the small molecules (impurities) being washed out through the membrane by solvent addition. The addition of fresh solvent was synchronized with the permeate flow so that the fill level in the feed container remained constant. The experiment was performed at 50° C. and 3 bar and altogether 25 L of fresh heptane were added (5 washing volumes in relation to the starting volume of the polymer solution). 5 L of polymer solution were obtained as retentate after this purification. 25 L of permeate solution were also obtained.

Heat Treatment at 180° C.

For analytical purposes 10 mL of the retentate (purified polymer solution) were dried in an aluminium dish in a vacuum drying cabinet over 20 h at 180° C. and a vacuum of 1 mbar after inertization with nitrogen. 1.5 g of white solid were obtained. The NMR spectrum of the solid corresponded to the expected structure of a polyoctenamer which contained 0.25 mol % of vinyl end groups and 0.30 mol % of cyclohexene end groups.

¹H NMR (CDCl₃, 500 MHz, 30° C.) δ (ppm): polyoctenamer: 5.38, 5.34, 2.01, 1.96, 1.30; end groups: 5.81 (m, 1H, —CH2═CH—CH2-), 5.66 (d, 2H, CH2-CH═CH—CH2), 5.38-5.34 (m, 2H, —CH—CH═CH—CH2), 4.95 (m, 2H, CH2═CH—CH2-).

Melting point: 54° C.
Melting enthalpy: 75 J/g
Molar mass M_{w}: 135 000 g/mol
Oligomer proportion (M<3000 g/mol): 3.8%

A trace elemental analysis showed that the polymer contained 250 ppm of tungsten, 125 ppm of aluminium and 110 ppm of chlorine.

### Example 2A: Synthesis of Polyolyoctenamer in Heptane with Ru Catalyst

1 L of heptane, 300 g of cyclooctene (COE) and 1.03 g of vinyl cyclohexene (VCH) were charged into a dry 2 L glass reactor under argon. The reaction mixture was heated to 70° C. and a solution of 14.4 mg of tricyclohexylphosphine[1,3-bis(2,4,6-trimethylphenyl)-4,5-dimethylimidazol-2-ylidene](2-thienylmethyliden)ruthenium(II) dichloride (catalyst C3) in 3.27 mL of toluene was added. A temperature increase of 16° C. was observed and the reaction mixture became markedly more viscous. The contents of the reactor were then discharged and a solution of 30% by weight of polyoctenamer in heptane was obtained.

### Example 2B (Comparative Example): Membrane Purification of Polyoctenamer in Heptane with Ru Catalyst

1.25 L of the solution of 20% by weight of polyoctenamer in heptane (produced as per example 2A) was further diluted to 5% by weight with 3.75 L of heptane. The obtained 5 L of polymer solution was purified by diafiltration through a PuraMem® UF (cut-off about 35 000 Da) ultrafiltration polymer membrane from Evonik Resource Efficiency GmbH. This was carried out using a crossflow filtration system with an 1812 membrane module (membrane area about 0.14 m²). The addition of fresh solvent was synchronized with the permeate flow so that the fill level in the feed container remained constant. The experiment was performed at 50° C. and 3 bar and altogether 25 L of fresh heptane were added (5 washing volumes in relation to the starting volume of the polymer solution). 5 L of polymer solution were obtained as retentate after this purification. 25 L of permeate solution were also obtained.

Heat Treatment at 80° C.

For analytical purposes 10 mL of this solution were dried in an aluminium dish in a vacuum drying cabinet over 3 h at 80° C. and a vacuum of 1 mbar after inertization with nitrogen. 2 g of white solid were obtained. The NMR spectrum of the solid partly corresponded to the expected structure of a polyoctenamer (see above) but the end groups (vinyl and cyclohexene end groups) were absent and unknown signals were observed in the olefin region.

Heat Treatment at 180° C.

For analytical purposes 10 mL of this solution were dried in an aluminium dish in a vacuum drying cabinet over 20 h at 180° C. and a vacuum of 1 mbar after inertization with nitrogen. 2 g of white solid were obtained. The NMR spectrum of the solid partly corresponded to the expected structure of a polyoctenamer (see above) but the end groups (vinyl and cyclohexene end groups) were absent and unknown signals were observed in the olefin region.

Melting point: 30° C.
Melting enthalpy: 58 J/g

The markedly lower melting point and melting enthalpy values compared to drying at 80° C. showed that the polymer was unstable at a temperature of 180° C. The polymer solution contained fine grey particles that blocked the membrane so that further use thereof was not possible. The grey particles were presumably inorganic ruthenium-containing compounds which were insoluble and remained in the polymer after drying.

### Example 3A (Comparative Example): Synthesis of Polyoctenamer in Heptane with Ru Catalyst and Addition of Butyl Vinyl Ether

1 L of heptane, 300 g of cyclooctene (COE) and 1.03 g of vinyl cyclohexene (VCH) were charged into a dry 2 L glass reactor under argon. The reaction mixture was heated to 70° C. and a solution of 14.4 mg of tricyclohexylphosphine[1,3-bis(2,4,6-trimethylphenyl)-4,5-dimethylimidazol-2-ylidene](2-thienylmethyliden)ruthenium(11) dichloride (catalyst C3) in 3.27 mL of toluene was added. A temperature increase of 17° C. was observed and the reaction mixture became markedly more viscous. After 30 min the temperature had returned to 70° C. and 2.73 g of butyl vinyl ether were added. After 2 h at 70° C. the contents of the reactor were discharged and a solution of 30% by weight of polyoctenamer in heptane was obtained.

Heat Treatment at 80° C.

For analytical purposes 10 mL of this solution were dried in an aluminium dish in a vacuum drying cabinet over 3 h at 80° C. and a vacuum of 1 mbar after inertization with nitrogen. 2 g of white solid were obtained. The NMR spectrum of the solid corresponded to the expected structure of a polyoctenamer which contained 0.31 mol % of vinyl end groups and 0.33 mol % of cyclohexene end groups.

¹H NMR (CDCl₃, 500 MHz, 30° C.) δ (ppm): polyoctenamer: 5.38, 5.34, 2.01, 1.96, 1.30; end groups: 5.81 (m, 1H, —CH2═CH—CH2-), 5.66 (d, 2H, CH2-CH═CH—CH2), 5.38-5.34 (m, 2H, —CH—CH═CH—CH2), 4.95 (m, 2H, CH2═CH—CH2-).

Melting point: 57° C.
Melting enthalpy: 78 J/g
Molar mass M_{w}: 104 000 g/mol
Oligomer proportion (M<3000 g/mol): 6%

Heat Treatment at 180° C.

For analytical purposes 10 mL of this solution were dried in an aluminium dish in a vacuum drying cabinet over 20 h at 180° C. and a vacuum of 1 mbar after inertization with nitrogen. 2 g of white solid were obtained. The NMR spectrum of the solid partly corresponded to the expected structure of a polyoctenamer (see above) but the end groups (vinyl and cyclohexene end groups) were absent and unknown signals were observed in the olefin region.

Melting point: 42° C.
Melting enthalpy: 64 J/g

The markedly lower melting point and melting enthalpy compared to drying at 80° C. showed that the polymer was unstable at a temperature of 180° C. A trace elemental analysis showed that the polymer contained 3 ppm of ruthenium.

### Example 3B (Inventive): Membrane Purification of Polyoctenamer in Heptane with Ru Catalyst and Addition of Butyl Vinyl Ether

1.25 L of the solution of 20% by weight of polyoctenamer in heptane (produced as per example 3A) was further diluted to 5% by weight with 3.75 L of heptane. The obtained 5 L of polymer solution was purified by diafiltration through a PuraMem® UF (cut-off about 35 000 Da) ultrafiltration polymer membrane from Evonik Resource Efficiency GmbH. This was carried out using a crossflow filtration system with an 1812 membrane module (membrane area about 0.14 m²). The addition of fresh solvent was synchronized with the permeate flow so that the fill level in the feed container remained constant. The experiment was performed at 50° C. and 3 bar and altogether 25 L of fresh heptane were added (5 washing volumes in relation to the starting volume of the polymer solution). 5 L of polymer solution were obtained as retentate after this purification. 25 L of permeate solution were also obtained.

Heat Treatment at 180° C.

For analytical purposes 10 mL of the retentate (purified polymer solution) were dried in an aluminium dish in a vacuum drying cabinet over 20 h at 180° C. and a vacuum of 1 mbar after inertization with nitrogen. 2 g of white solid were obtained. The NMR spectrum of the solid corresponded to the expected structure of a polyoctenamer which contained 0.29 mol % of vinyl end groups and 0.30 mol % of cyclohexene end groups.

¹H NMR (CDCl₃, 500 MHz, 30° C.) δ (ppm): polyoctenamer: 5.38, 5.34, 2.01, 1.96, 1.30; end groups: 5.81 (m, 1H, —CH2═CH—CH2-), 5.66 (d, 2H, CH2-CH═CH—CH2), 5.38-5.34 (m, 2H, —CH—CH═CH—CH2), 4.95 (m, 2H, CH2═CH—CH2-).

Melting point: 57° C.
Melting enthalpy: 78 J/g
Molar mass M_{w}: 113 000 g/mol
Oligomer proportion (M<3000 g/mol): 3.2%

The high melting point (>56° C.) and the high melting enthalpy (>75 J/g) showed that the purified polyoctenomer was stable under the temperature conditions at 180° C.

The reduction in the oligomer proportion in the GPC compared to the starting solution (see example 3A) showed that this purification by ultrafiltration allowed separation of oligomers. A trace elemental analysis showed that the polymer contained only 1.5 ppm of ruthenium. In addition, no insoluble particles in the polymer solution were observed.

### Example 4A (Comparative Example): Synthesis of Polyoctenamer in Heptane with Ru Catalyst and Addition of Ethyl Vinyl Sulfide

1 L of heptane, 300 g of cyclooctene (COE) and 1.03 g of vinyl cyclohexene (VCH) were charged into a dry 2 L glass reactor under argon. The reaction mixture was heated to 60° C. and a solution of 14.4 mg of tricyclohexylphosphine[1,3-bis(2,4,6-trimethylphenyl)-4,5-dimethylimidazol-2-ylidene](2-thienylmethyliden)ruthenium(11) dichloride (catalyst C3) in 3.27 mL of toluene was added. A temperature increase of 20° C. was observed and the reaction mixture became markedly more viscous. After 30 min the temperature had returned to 65° C. and 2.41 g of ethyl vinyl sulfide were added. After 2 h at 60° C. the contents of the reactor were discharged and a solution of 30% by weight of polyoctenamer in heptane was obtained.

Heat Treatment at 80° C.

For analytical purposes 10 mL of this solution were dried in an aluminium dish in a vacuum drying cabinet over 3 h at 80° C. and a vacuum of 1 mbar after inertization with nitrogen. 2 g of white solid were obtained. The NMR spectrum of the solid corresponded to the expected structure of a polyoctenamer which contained 0.31 mol % of vinyl end groups and 0.33 mol % of cyclohexene end groups.

¹H NMR (CDCl₃, 500 MHz, 30° C.) δ (ppm): polyoctenamer: 5.38, 5.34, 2.01, 1.96, 1.30; end groups: 5.81 (m, 1H, —CH2═CH—CH2-), 5.66 (d, 2H, CH2-CH═CH—CH2), 5.38-5.34 (m, 2H, —CH—CH═CH—CH2), 4.95 (m, 2H, CH2═CH—CH2-).

Melting point: 57° C.
Melting enthalpy: 79 J/g
Molar mass M_{w}: 110 000 g/mol
Oligomer proportion (M<3000 g/mol): 3%

Heat Treatment at 180° C.

For analytical purposes 10 mL of this solution were dried in an aluminium dish in a vacuum drying cabinet over 20 h at 180° C. and a vacuum of 1 mbar after inertization with nitrogen. 2 g of white solid were obtained. The NMR spectrum of the solid partly corresponded to the expected structure of a polyoctenamer (see above) but the end groups (vinyl and cyclohexene end groups) were absent and unknown signals were observed in the olefin region.

Melting point: 40° C.
Melting enthalpy: 62 J/g

The markedly lower melting point and melting enthalpy compared to drying at 80° C. showed that the polymer was unstable at a temperature of 180° C. A trace elemental analysis showed that the polymer contained 5 ppm of ruthenium.

### Example 4B (Inventive): Membrane Purification of Polyoctenamer in Heptane with Ru Catalyst and Addition of Ethyl Vinyl Sulfide

1.25 L of the solution of 20% by weight of polyoctenamer in heptane (produced as per example 3A) was further diluted to 5% by weight with 3.75 L of heptane. The obtained 5 L of polymer solution was purified by diafiltration through a PuraMem® UF (cut-off about 35 000 Da) ultrafiltration polymer membrane from Evonik Resource Efficiency GmbH. This was carried out using a crossflow filtration system with an 1812 membrane module (membrane area about 0.14 m²). The addition of fresh solvent was synchronized with the permeate flow so that the fill level in the feed container remained constant. The experiment was performed at 50° C. and 3 bar and altogether 25 L of fresh heptane were added (5 washing volumes in relation to the starting volume of the polymer solution). 5 L of polymer solution were obtained as retentate after this purification. 25 L of permeate solution were also obtained.

Heat Treatment at 180° C.

For analytical purposes 10 mL of the retentate (purified polymer solution) were dried in an aluminium dish in a vacuum drying cabinet over 20 h at 180° C. and a vacuum of 1 mbar after inertization with nitrogen. 2 g of white solid were obtained. The NMR spectrum of the solid corresponded to the expected structure of a polyoctenamer which contained 0.29 mol % of vinyl end groups and 0.30 mol % of cyclohexene end groups.

¹H NMR (CDCl₃, 500 MHz, 30° C.) δ (ppm): polyoctenamer: 5.38, 5.34, 2.01, 1.96, 1.30; end groups: 5.81 (m, 1H, —CH2═CH—CH2-), 5.66 (d, 2H, CH2-CH═CH—CH2), 5.38-5.34 (m, 2H, —CH—CH═CH—CH2), 4.95 (m, 2H, CH2═CH—CH2-).

Melting point: 57° C.
Melting enthalpy: 80 J/g
Molar mass M_{w}: 125 000 g/mol
Oligomer proportion (M<3000 g/mol): 0.7%

The high melting point (>56° C.) and the high melting enthalpy (>75 J/g) showed that the purified polyoctenomer was stable under the temperature conditions at 180° C.

The reduction in the oligomer proportion in the GPC compared to the starting solution (see example 4A) showed that this purification by ultrafiltration allowed separation of oligomers. A trace elemental analysis showed that the polymer contained only 2.4 ppm of ruthenium. In addition, no insoluble particles in the polymer solution were observed.

### Example 5A: Synthesis of Polyoctenamer in Toluene with Ru Catalyst and Addition of Butyl Vinyl Ether

380 mL of toluene, 80 g of cyclooctene (COE) and 0.275 g of vinyl cyclohexene (VCH) were charged into a dry 2 L glass reactor under argon. The reaction mixture was heated to 70° C. A solution of 6.4 mg of tricyclohexylphosphine[1,3-bis(2,4,6-trimethylphenyl)-4,5-dimethylimidazol-2-ylidene](2-thienylmethyliden)ruthenium(11) dichloride (catalyst C3) in 1.45 mL of toluene was then added. The reaction temperature increased to 74° C. after 5 min and then fell to 70° C. again. The reaction mixture became markedly more viscous. 30 Min after the catalyst addition 0.73 g of butyl vinyl ether were added and the mixture was stirred at 70° C. over 2 h. The contents of the reactor were then discharged and a solution of 20% by weight of polyoctenamer in toluene was obtained.

Heat Treatment at 80° C.

For analytical purposes 10 mL of this solution were dried in an aluminium dish in a vacuum drying cabinet over 3 h at 80° C. and a vacuum of 1 mbar after inertization with nitrogen. 1.7 g of white solid were obtained. The NMR spectrum of the solid corresponded to the expected structure of a polyoctenamer which contained 0.3 mol % of vinyl end groups and 0.32 mol % of cyclohexene end groups.

¹H NMR (CDCl₃, 500 MHz, 30° C.) δ (ppm): polyoctenamer: 5.38, 5.34, 2.01, 1.96, 1.30; end groups: 5.81 (m, 1H, —CH2═CH—CH2-), 5.66 (d, 2H, CH2-CH═CH—CH2), 5.38-5.34 (m, 2H, —CH—CH═CH—CH2), 4.95 (m, 2H, CH2═CH—CH2-).

Melting point: 56° C.
Melting enthalpy: 78 J/g
Molar mass M_{w}: 101 000 g/mol
Oligomer proportion (M<3000 g/mol): 8%

Heat Treatment at 180° C.

For analytical purposes 10 mL of this solution were dried in an aluminium dish in a vacuum drying cabinet over 20 h at 180° C. and a vacuum of 1 mbar after inertization with nitrogen. 1.7 g of white solid were obtained. The NMR spectrum of the solid partly corresponded to the expected structure of a polyoctenamer (see above) but the end groups (vinyl and cyclohexene end groups) were absent and unknown signals were observed in the olefin region.

Melting point: 28° C.
Melting enthalpy: 66 J/g

The markedly lower melting point (<30° C.) and melting enthalpy (<70 J/g) values compared to drying at 80° C. showed that the polymer was unstable at a temperature of 180° C. A trace elemental analysis showed that the polymer contained 5 ppm of ruthenium.

### Example 5B (Inventive): Membrane Purification of Polyoctenamer in Toluene with Ru Catalyst and Addition of Butyl Vinyl Ether

125 mL of the solution of 20% by weight of polyoctenamer in toluene from example 4A was dilute with 375 mL of toluene. The obtained 500 mL of polymer solution (5% by weight in toluene) was filtered through a PuraMem® UF (cut-off about 35 000 Da) ultrafiltration polymer membrane from Evonik Resource Efficiency GmbH. A crossflow filtration plant with 4 test cells and a total membrane area of 136 cm² was used. The experiment was performed at 50° C. and 3 bar and altogether 3.5 L of fresh toluene were added (7 washing volumes in relation to the starting volume of the polymer solution). 500 mL of polymer solution were obtained as retentate after this purification. 3.5 L of permeate solution were also obtained.

Heat Treatment at 180° C.

For analytical purposes 10 mL of this retentate solution were dried in an aluminium dish in a vacuum drying cabinet over 20 h at 180° C. and a vacuum of 1 mbar after inertization with nitrogen. 1.7 g of white solid were obtained. The NMR spectrum of the solid corresponded to the expected structure of a polyoctenamer which contained 0.3 mol % of vinyl end groups and 0.32 mol % of cyclohexene end groups.

¹H NMR (CDCl₃, 500 MHz, 30° C.) δ (ppm): polyoctenamer: 5.38, 5.34, 2.01, 1.96, 1.30; end groups: 5.81 (m, 1H, —CH2═CH—CH2-), 5.66 (d, 2H, CH2-CH═CH—CH2), 5.38-5.34 (m, 2H, —CH—CH═CH—CH2), 4.95 (m, 2H, CH2═CH—CH2-).

Melting point: 59° C.
Melting enthalpy: 78 J/g
Molar mass M_{w}: 119 000 g/mol
Oligomer proportion (M<3000 g/mol): 1.4%

The high melting point (>56° C.) and the high melting enthalpy (>75 J/g) showed that the purified polyoctenomer was stable under the temperature conditions at 180° C. The reduction in the oligomer proportion in the GPC compared to the starting solution (see example 4A) showed that this purification by ultrafiltration allowed separation of oligomers. A trace element analysis showed that the polymer contained less than 1 ppm of ruthenium (amount below detection limit).

### Example 6A: Synthesis of Polyoctenamer in Heptane with Tungsten/Aluminium Catalyst System and Addition of Butyl Vinyl Ether

585 mL of heptane, 100 g of cyclooctene (COE) and 0.34 g of vinyl cyclohexene (VCH) were charged into a dry 2 L glass reactor under argon. The reaction mixture was heated to 30° C. and 0.4 mL of a solution of ethylaluminium dichloride (20% by weight) in heptane was added. Subsequently, 1 mL of a solution of tungsten hexachloride/propylene oxide (⅓ mol/mol) in toluene (2.8% by weight of tungsten) were added slowly. A temperature increase of 5° C. was observed and the reaction mixture became markedly more viscous. The contents of the reactor were then discharged and a solution of 20% by weight of polyoctenamer in heptane was obtained.

### Example 6B (Comparative Example): Membrane Purification of Polyoctenamer in Heptane with Tungsten/Aluminium Catalyst System and Addition of Butyl Vinyl Ether

1.25 L of the solution of 20% by weight of polyoctenamer in heptane (produced as per example 5A) was further diluted to 5% by weight with 3.75 L of heptane. The obtained 5 L of polymer solution was purified by diafiltration through a PuraMem® UF (cut-off about 35 000 Da) ultrafiltration polymer membrane from Evonik Resource Efficiency GmbH. This was carried out using a crossflow filtration system with an 1812 membrane module (membrane area about 0.14 m²). The addition of fresh solvent was synchronized with the permeate flow so that the fill level in the feed container remained constant. The experiment was performed at 50° C. and 3 bar and altogether 25 L of fresh heptane were added (5 washing volumes in relation to the starting volume of the polymer solution). 5 L of polymer solution were obtained as retentate after this purification. 25 L of permeate solution were also obtained.

Heat Treatment at 180° C.

For analytical purposes 10 mL of the retentate (purified polymer solution) were dried in an aluminium dish in a vacuum drying cabinet over 20 h at 180° C. and a vacuum of 1 mbar after inertization with nitrogen. 1.5 g of white solid were obtained. The NMR spectrum of the solid corresponded to the expected structure of a polyoctenamer which contained 0.25 mol % of vinyl end groups and 0.30 mol % of cyclohexene end groups.

¹H NMR (CDCl₃, 500 MHz, 30° C.) δ (ppm): polyoctenamer: 5.38, 5.34, 2.01, 1.96, 1.30; end groups: 5.81 (m, 1H, —CH2═CH—CH2-), 5.66 (d, 2H, CH2-CH═CH—CH2), 5.38-5.34 (m, 2H, —CH—CH═CH—CH2), 4.95 (m, 2H, CH2═CH—CH2-).

Melting point: 54° C.
Melting enthalpy: 75 J/g
Molar mass M_{w}: 135 000 g/mol
Oligomer proportion (M<3000 g/mol): 3.8%

A trace elemental analysis showed that the polymer contained 250 ppm of tungsten, 125 ppm of aluminium and 110 ppm of chlorine.

### SUMMARY

| | | | Addition of | | |
|---|---|---|---|---|---|
| | | | alkyl vinyl | | Results after |
| | | | derivative | Membrane | 180° C. heat |
| Example | Catalyst | Solvent | after reaction | filtration | treatment |
| 1A | EADC/WCl₆ | heptane | no | no | m.p. 54° C., |
| | | | | | 250 ppm W, |
| | | | | | 125 ppm Al, |
| | | | | | 110 ppm Cl |
| 1B | EADC/WCl₆ | heptane | no | 5 washing | m.p. 54° C., |
| | | | | volumes | 250 ppm W, |
| | | | | | 125 ppm Al |
| 2A | C3 | heptane | no | no | m.p. 30° C., |
| | | | | | 10 ppm Ru |
| 2B | C3 | heptane | no | 5 washing | m.p. 30° C., |
| | | | | volumes | precipitation of |
| | | | | | grey particles |
| 3A | C3 | heptane | butyl vinyl | no | m.p. 42° C., |
| | | | ether | | 3 ppm Ru |
| 3B* | C3 | heptane | butyl vinyl | 5 washing | m.p. 59° C., |
| | | | ether | volumes | 1.5 ppm Ru |
| 4A | C3 | heptane | ethyl vinyl | no | m.p. 40° C., |
| | | | sulfide | | 5 ppm Ru |
| 4B* | C3 | heptane | ethyl vinyl | 5 washing | m.p. 57° C., |
| | | | sulfide | volumes | 2.4 ppm Ru |
| 5A | C3 | toluene | butyl vinyl | no | m.p. 28° C. |
| | | | ether | | 5 ppm Ru |
| 5B* | C3 | toluene | butyl vinyl | 7 washing | m.p. 59° C. |
| | | | ether | volumes | <1 ppm Ru |
| 6B | EADC/WCl₆ | heptane | butyl vinyl | 5 washing | m.p. 54° C. |
| | | | ether | volumes | 250 ppm W, |
| | | | | | 125 ppm Al, |
| | | | | | 110 ppm Cl |

*inventive
EADC = Ethylaluminium dichloride,
m.p. = melting point

Polyoctenamer synthesized with tungsten catalyst and subsequently subjected to a membrane filtration shows a melting point below 57° C. High chlorine and metal proportions are also present (cf. example 1B). An addition of an alkyl vinyl ether (example 6B) does not show any change in melting point and metal proportions.

In the ruthenium-catalyzed production of polyalkenamer a membrane filtration without alkyl vinyl ether results in a precipitation of grey particles with a very low melting point of 30° C. (example 2B). When alkyl vinyl ether or alkyl vinyl sulfide are added without performing a membrane filtration the polymers at 180° C. are not thermally stable (melting point in example 3A: 42° C., example 4A: 40° C., example 5A: 28° C.) and the metal proportion in the polymer is higher.

The combination of ruthenium catalyst, alkyl vinyl ether addition and membrane filtration results in a polyoctenamer which is thermally stable at 180° C. and has a high melting point of 57° C. or 59° C.

1-14. (canceled)

15. A process for producing a polyalkenamer-containing composition, comprising the steps of:
a) reacting at least one cycloalkene by ring-opening metathesis polymerization in at least one organic solvent to obtain a polyalkenamer-containing product mixture, wherein the polymerization is performed in the presence of at least one metal-containing catalyst and wherein the metal is selected from rhenium, ruthenium, osmium or mixtures thereof, wherein the cycloalkene is selected from the group consisting of cyclobutene, cyclopentene, cycloheptene, cyclooctene, cyclononene, cyclodecene, cyclododecene, cycloocta-1,5-diene, 1,5-dimethylcycloocta-1,5-diene, cyclodecadiene, norbornadiene, cyclododeca-1,5,9-triene, trimethylcyclododeca-1,5,9-triene, norbornene (bicyclo[2.2.1]hept-2-ene), 5-(3′-cyclohexenyl)-2-norbornene, 5-ethyl-2-norbornene, 5-vinyl-2-norbomene, 5-ethylidene-2-norbornene, dicyclopentadiene and mixtures thereof,
b) adding at least one alkyl vinyl derivative selected from alkyl vinyl ether, alkyl vinyl sulfide or mixtures thereof after the polymerization and
c) working up the product mixture to remove the catalyst to obtain the polyalkenamer-containing composition, wherein the workup is carried out by membrane filtration in at least one organic solvent.

16. The process of claim 15, wherein the alkyl vinyl derivative is selected from the group consisting of: methyl vinyl ether, ethyl vinyl ether, propyl vinyl ether, butyl vinyl ether and mixtures thereof.

17. The process of claim 16, wherein methyl vinyl sulfide, ethyl vinyl sulfide, propyl vinyl sulfide, butyl vinyl sulfide and mixtures thereof are added as the alkyl vinyl sulfide.

18. The process of claim 15, wherein the membrane of the membrane filtration has a separation-active layer selected from polymers, glass, metal, ceramic or mixtures thereof.

19. The process of claim 18, wherein the separation-active layer of the membrane is selected from the group consisting of: crosslinked silicone acrylates, polydimethylsiloxane (PDMS) and polyimide.

20. The process of claim 15, wherein the membrane filtration is an ultrafiltration.

21. The process of claim 15, wherein the cycloalkene is selected from the group consisting of cyclopentene, cycloheptene, cyclooctene, cyclododecene and mixtures thereof.

22. The process of claim 21, wherein the cycloalkene comprises cyclooctene.

23. The process of claim 15, wherein the polymerization is performed in a nonpolar aromatic or aliphatic solvent.

24. The process of claim 15, wherein the same solvent is used for the polymerization and the membrane filtration.

25. The process of claim 15, wherein the metal of the catalyst comprises ruthenium.

26. The process of claim 15, wherein the reaction of cycloalkenes is carried out in the presence of a chain transfer agent.

27. The process of claim 15, wherein the chain transfer agent is a acyclic alkene having one or more non-conjugated double bonds, or a cyclic compound having a double bond in their side chain.

28. The process of claim 21, wherein the polymerization is performed in a nonpolar aromatic or aliphatic solvent.

29. The process of claim 21, wherein the metal of the catalyst comprises ruthenium.

30. The process of claim 22, wherein the reaction of cycloalkenes is carried out in the presence of a chain transfer agent.

31. The process of claim 30, wherein the chain transfer agent is a acyclic alkene having one or more non-conjugated double bonds, or a cyclic compound having a double bond in its side chain.

32. The process of claim 30, wherein the membrane filtration is an ultrafiltration.

33. The process of claim 29, wherein the alkyl vinyl derivative is selected from the group consisting of: methyl vinyl ether, ethyl vinyl ether, propyl vinyl ether, butyl vinyl ether and mixtures thereof.

34. The process of claim 33, wherein methyl vinyl sulfide, ethyl vinyl sulfide, propyl vinyl sulfide, butyl vinyl sulfide and mixtures thereof are added as the alkyl vinyl sulfide.
